(19) United States
(12) Patent Application Publication
(10) Pub. No.: US 2017/0227104 A1
(43) Pub. Date: Aug. 10, 2017

(54) TORQUE VECTORING DEVICE

(71) Applicants: TOYOTA JIDOSHA KABUSHIKI KAISHA, Toyota-shi (JP); ALCHEMICA CORPORATION, Susono-shi (JP)

(72) Inventors: Hiroshi ISONO, Susono-shi (JP); Nobuyoshi SUGITANI, Susono-shi (JP); Aizoh KUBO, Kyoto-shi (JP)

(73) Assignees: TOYOTA JIDOSHA KABUSHIKI KAISHA, Toyota-shi (JP); ALCHEMICA CORPORATION, Susono-shi (JP)

(21) Appl. No.: 15/428,468

(22) Filed: Feb. 9, 2017

(30) Foreign Application Priority Data
Feb. 9, 2016 (JP) 2016-022558

(51) Int. Cl. F16H 48/36; F16H 48/10

(52) U.S. Cl. CPC F16H 48/36; F16H 48/10; F16H 2048/104; F16H 2048/106; F16H 2048/364

(57) ABSTRACT

A torque vectoring device for preventing an unintentional relative rotation between the right wheel and the left wheel is provided. The torque vectoring device comprises: a drive motor; a differential unit formed of planetary gear units; a differential motor that applies torque to any one of reaction elements of the planetary gear units; a torque reversing mechanism transmitting torque of the first reaction element to the second reaction element while reversing; a rotary shaft connecting input elements of the planetary gear units; a first rotary member fitted onto an output shaft of the differential motor; and a differential action restricting mechanism for pushing a pushing member onto the first rotary member thereby applying brake torque to the output shaft of the differential motor.

### CROSS REFERENCE TO RELATED APPLICATION

The present invention claims the benefit of Japanese Patent Application No. 2016-022558 filed on Feb. 9, 2016 with the Japanese Patent Office, the disclosures of which are incorporated herein by reference in its entirety.

### BACKGROUND

Field of the Invention

Embodiments of the present application relate to the art of a torque vectoring device for controlling a split ratio of a torque generated by a drive motor to right and left drive wheels.

Discussion of the Related Art

PCT international publication WO 2015/008661 describes one example of a torque vectoring device of this kind. The drive gear unit taught by WO 2015/008661 as a torque vectoring device comprises a differential unit for distributing torque delivered from a drive motor to right and left drive wheels, and a differential motor for controlling a torque split ratio to the drive wheels. The differential unit is comprised of a pair of single-pinion planetary gear units. In differential unit, sun gears are rotated by a torque of the drive motor, ring gears of are connected to each other in such a manner as to rotate in opposite directions, and the carriers are connected to drive wheels through driveshafts.

In the torque vectoring device taught by WO 2015/008661, the rotary members are arranged parallel to each other so that the carriers are allowed to rotate smoothly to reduce a power loss. However, if the torque vectoring device taught by WO 2015/008661 is used in an automobile, a relative rotation between the right drive wheel and the left drive wheel may be caused unintentionally due to difference in friction coefficients of a road surface or unevenness of the road surface. Such disadvantage may be solved by a differential motor. However, a complicated program is required to control the differential motor, and vibrations may be generated by a pulsation of output torque of the differential motor.

### SUMMARY

Aspects of embodiments of the present application have been conceived noting the foregoing technical problems, and it is therefore an object of embodiments of the present application is to provide a torque vectoring device that can prevent an unintentional relative rotation between the right wheel and the left wheel.

The present application relates to a torque vectoring device, comprising: a drive motor; a differential unit including a first planetary gear unit and a second planetary gear unit. The first planetary gear unit comprises a first input element to which torque of the drive motor is applied, a first output element connected to one of drive wheels, and a first reaction element which establishes reaction torque to output the torque of first input element from the first output element. The second planetary gear unit comprises a second input element to which torque of the drive motor is applied, a second output element connected to the other drive wheel, and a second reaction element which establishes reaction torque to output the torque of second input element from the second output element. The torque vectoring device further comprises: a differential motor that applies torque to any one of the first reaction element and the second reaction element; a torque reversing mechanism that transmits the torque of the first reaction element to the second reaction element while reversing a direction; and a rotary shaft connecting the first input element and the second input element. In order to achieve the above-explained objective, according to the embodiment of the present application, the torque vectoring device is provided with: a first rotary member fitted onto an output shaft of the differential motor; and a differential action restricting mechanism that brings a pushing member into frictional contact to the first rotary member thereby applying brake torque to the output shaft of the differential motor.

In a non-limiting embodiment, the torque vectoring device may further comprise: a second rotary member fitted onto an output shaft of the drive motor; another pushing member that is selectively brought into frictional contact to the second rotary member; and a first electromagnetic actuator that is energized to reciprocate said another pushing member toward and away from second rotary member.

In a non-limiting embodiment, the first electromagnetic actuator may include a parking motor, the parking motor may comprise a first male thread formed on an outer circumferential face of an output shaft of the parking motor, the first electromagnetic actuator may further include an annular plate member having a first female thread formed on an inner circumferential face thereof to be mated with the first male thread, and the plate member pushes said another pushing member toward the second rotary member.

In a non-limiting embodiment, the differential action restricting mechanism may include a second electromagnetic actuator that reduces a frictional force applied to the first rotary member when energized.

In a non-limiting embodiment, the second electromagnetic actuator may include a differential action restricting motor, and the second electromagnetic actuator may comprise a second male thread formed on an outer circumferential face of an output shaft of the differential action restricting motor, and a second female thread is formed on an inner circumferential face of the pushing member to be mated with the second male thread.

In a non-limiting embodiment, the first planetary gear unit may serve as a speed reducer when the first reaction element is rotated slower than the first input element, and the second planetary gear unit may serve as a speed reducer when the second reaction element is rotated slower than the second input element.

Thus, according to the embodiment of the present application, the differential unit is formed of the first planetary gear unit and the second planetary gear unit. The reaction elements of those planetary gear units are connected to each other through the torque reversing mechanism, and one of the reaction elements is connected to the differential motor. In the torque vectoring device according to the embodiment, therefore, reaction torque of one of the reaction elements can be increased while reducing reaction torque of the other reaction torque by applying output torque of the differential motor. For this reason, torque split ratio to the right drive wheel and the left drive wheel can be changed by changing the output torque of the differential motor. In addition, an unintentional relative rotation between the right drive wheel and the left drive wheel can be prevented by applying brake torque of the differential action restricting mechanism to the output shaft of the differential motor without requiring a complicated program.

In addition to the above-mentioned advantages, an unintentional turning of the vehicle resulting from relative rotation between the right drive wheel and the left drive wheel during braking can be prevented by applying the brake torque of the differential action restricting mechanism to the output shaft of the differential motor while pushing another pushing member onto the second rotary member fitted onto the output shaft of the drive motor.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1 is a cross-sectional view showing a structure of the torque vectoring device according to the preferred embodiment of the present application; and

FIG. 2 is a cross-sectional view showing another example of the second brake device.

### DETAILED DESCRIPTION OF THE PREFERRED EMBODIMENT(S)

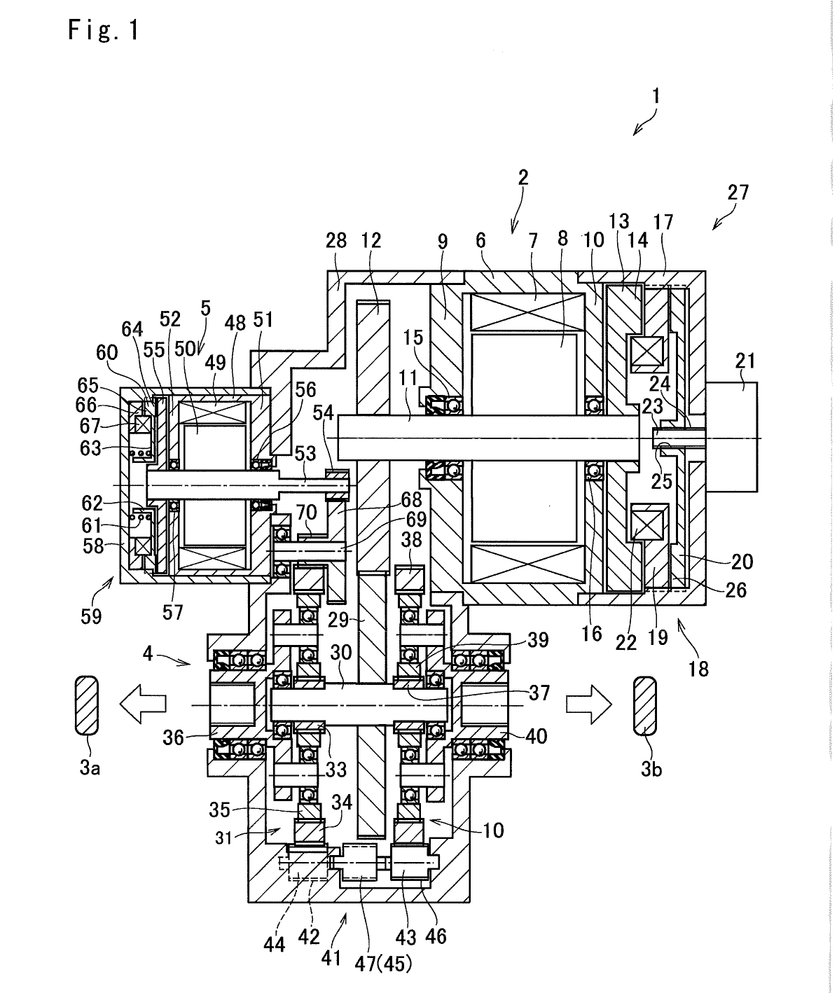

The preferred embodiments of the present application will now be explained with reference to the accompanying drawings. Referring now to FIG. 1, there is shown a preferred embodiment of the torque vectoring device according to the present application. The torque vectoring device 1 shown in FIG. 1 comprises a drive motor 2 serving as a prime mover of a vehicle, a differential unit 4 that distributes an output torque of the drive motor 2 to a right drive wheel 3b and a left drive wheel 3a, and a differential motor 5 that controls a split ratio of a torque distributed to the right drive wheel 3b and the left drive wheel 3a.

For example, a permanent magnet synchronous motor may be used as the drive motor 2. Drive torque and brake torque of the drive motor 2 may be controlled by controlling a current value and a voltage applied to the drive motor 2. The drive motor 2 comprises a stator 7 fixed to an inner surface of a cylindrical first housing 6, and a rotor 8 fitted onto an output shaft 11 to be rotated integrally therewith. Both ends of the first housing 6 are closed by a first sidewall 9 and a second sidewall 10 individually having a through hole at the center.

Each end of the output shaft 11 individually protrudes from the through holes of the sidewalls 9 and 11. An output gear 12 is fitted onto one end of the output shaft 11, and a first disc 13 made of magnetic material is fitted onto the other end of the output shaft 11. An outer diameter of the first disc 13 is slightly smaller than an outer diameter of the first housing 6, and an annular depression 14 is formed on a face opposite to the drive motor 2. A ball bearing 15 is fitted into the through hole of the first sidewall 9 and a ball bearing 16 is fitted into the through hole of the second sidewall 10 so as to allow the output shaft 11 to rotate. Accordingly, the first disc 13 serves as the claimed “second rotary member”.

A cylindrically-bottomed first cover 17 having an inner diameter larger than the outer diameter of the first disc 13 is joined to the second sidewall 10 of the first housing 6. A first brake device 18 is held in a space enclosed by the first housing 6 and the first cover 17. The first brake device 18 comprises the first disc 13, an annular first pushing member 19 opposed to the annular depression 14 of the first disc 13, a parking motor 21 attached to an outer bottom face of the first cover 17 while inserting an output shaft 23 thereof into the first cover 17, and a plate member 20 fitted onto the output shaft 23 to be pushed by the parking motor 21 in an axial direction.

An outer circumferential edge of the first pushing member 19 is splined to an inner circumferential face of the first cover 17 so that the first pushing member 19 is allowed to reciprocate in the axial direction but restricted to be rotated. An inner circumferential portion of the first pushing member 19 protrudes toward the first disc 13 to be fitted into the annular depression 14, and a first coil 22 is wound around the inner circumferential portion of the first pushing member 19. Accordingly, the parking motor 21 and the first coil 22 serve as the claimed “first electromagnetic actuator”, and the first pushing member 19 serves as the claimed “another pushing member”.

A first male thread 24 is formed on an outer circumferential face of the output shaft 23 of the parking motor 21, and a first female thread 25 is formed on an inner circumferential face of the plate member 20 to be mated with the first male thread 24. An outer circumferential edge of the plate member 20 is also splined to the inner circumferential face of the first cover 17 so that the plate member 20 is allowed to reciprocate in the axial direction by actuating the parking motor 21. Thus, the output shaft 23 and the plate member 20 serve as a feed screw mechanism. In addition, an annular protrusion 26 protruding toward the first pushing member 19 is formed on an outer circumferential portion of the plate member 20 to be contacted to the first pushing member 19.

Here will be explained an action of the first brake device 18. The first coil 22 generates a magnetic force by applying current thereto, and the first pushing member 19 is brought into frictional contact to the first disc 13 by the magnetic force. In this situation, since the first pushing member 19 is not allowed to rotate, a rotational speed of the first disc 13 is reduced by the friction acting between the first disc 13 and the first pushing member 19. Consequently, a brake torque is applied to the output shaft 11 of the drive motor 2. The frictional force acting between the first disc 13 and the first pushing member 19 is changed depending on a current value applied to the first coil 22 and hence the brake torque can be controlled by controlling the current value applied to the first coil 22.

However, the brake torque applied to the output shaft 11 of the drive motor 2 cannot be maintained when the power is off to park the vehicle. In order to maintain a frictional contact between the first disc 13 and the first pushing member 19 during parking, current is applied to the parking motor 21 to keep pushing the first pushing member 19 by the plate member 20 when shutting the power off or when shifting a shift lever to a parking position, and then the current supply to the parking motor 21 is stopped. According to the preferred embodiment, therefore, an unintentional rotation of the drive motor 2 can be prevented during parking of the vehicle.

A drive unit 27 formed by the drive motor 2 and the first brake device 18 is attached to a casing 28 holding a differential unit 4, and consequently the output gear 12 is held in the casing 28. In the casing 28, the output gear 12 is meshed with a driven gear 29 fitted onto a rotary shaft 30 of the differential unit 4.

The rotary shaft 30 extends parallel to the output shaft 11 of the drive motor 2 to connect the first planetary gear unit 31 to the second planetary gear unit 32. According to the preferred embodiment, a single-pinion planetary gear unit is individually used as the first planetary gear unit 31 and the second planetary gear unit 32.

The first planetary gear unit 31 comprises: a first sun gear 33 fitted onto one end of the rotary shaft 30; a first ring gear 34 having both internal tooth and external tooth that is arranged concentrically with the first sun gear 33; a plurality of first planetary gears 35 interposed between the first sun gear 33 and the first ring gear 34 while meshing with external tooth of the first sun gear 33 and the internal tooth of the first ring gear 34; and a first carrier 36 supporting the first planetary gears 35 in such a manner as to allow the first planetary gears 35 around the first sun gear 33. The first carrier 36 is connected to the left drive wheel 3a through one of driveshafts (not shown). Accordingly, the first sun gear 33 serves as the claimed “first input element”, the first ring gear 34 serves as the claimed “first reaction element”, and the first carrier 36 serves as the claimed “first output element”.

The second planetary gear unit 32 comprises: a second sun gear 37 fitted onto the other end of the rotary shaft 30; a second ring gear 38 having both internal tooth and external tooth that is arranged concentrically with the second sun gear 37; a plurality of second planetary gears 39 interposed between the second sun gear 37 and the second ring gear 38 while meshing with external tooth of the second sun gear 37 and the internal tooth of the second ring gear 38; and a second carrier 40 supporting the second planetary gears 39 in such a manner as to allow the second planetary gears 39 around the second sun gear 37. The second carrier 40 is connected to the right drive wheel 3b through the other driveshaft (not shown). Accordingly, the second sun gear 37 serves as the claimed “second input element”, the second ring gear 38 serves as the claimed “second reaction element”, and the second carrier 40 serves as the claimed “second output element”.

The first ring gear 34 and the second ring gear 38 are connected to each other through a torque reversing mechanism 41 arranged parallel to the rotary shaft 30. The torque reversing mechanism 41 comprises a first connection shaft 42 supported by the casing 28 in a rotatable manner, and a second connection shaft 43. A first pinion gear 44 is formed on one end of the first connection shaft 42 to be meshed with the outer tooth of the first ring gear 34, and a second pinion gear 45 is formed on the other end of the first connection shaft 42. Likewise, a third pinion gear 46 is formed on one end of the second connection shaft 43 to be meshed with the outer tooth of the second ring gear 38, and a fourth pinion gear 47 is formed on the other end of the first connection shaft 42 to be meshed with the second pinion gear 45. Here, teeth number of the second pinion gear 45 and teeth number of the fourth pinion gear 47 are identical to each other so that the first connection shaft 42 and the second connection shaft 43 are rotated at same speeds in opposite directions. In the differential unit 4, a plurality of the torque reversing mechanism 41 are arranged around first planetary gear unit 31 and the second planetary gear unit 32 at regular intervals.

In order to apply torque to the first ring gear 34 and the second ring gear 38, the torque vectoring device 1 is provided with a differential motor 5. For example, a permanent magnet synchronous motor, and an induction motor may be used as the differential motor 5. Specifically, the differential motor 5 comprises a stator 49 attached to an inner circumferential face of a cylindrical second housing 48, and a rotor 50 fitted onto an output shaft 53 to be rotated integrally therewith. Both ends of the second housing 48 are closed by a third sidewall 51 and a fourth sidewall 52 individually having a through hole at the center.

Each end of the output shaft 53 individually protrudes from the through holes of the sidewalls 51 and 52. An output gear 54 is fitted onto one end of the output shaft 53, and a second disc 55 having an outer diameter slightly smaller than an outer diameter of the second housing 48 is fitted onto the other end of the output shaft 53. A ball bearing 56 is fitted into the through hole of the third sidewall 51 and a ball bearing 57 is fitted into the through hole of the fourth sidewall 52 so as to allow the output shaft 53 to rotate. Accordingly, the second disc 55 serves as the claimed “first rotary member”.

A cylindrically-bottomed second cover 58 having an inner diameter identical to an outer diameter of the second housing 48 is joined to the casing 28 around the second housing 48. In order to selectively stop the rotation of the output shaft 53 of the differential motor 5, a second brake device 59 is arranged in a space between a bottom face of the second cover 58 and the fourth sidewall 52. The second brake device 59 comprises the second disc 55, an annular second pushing member 60 made of magnetic material that is opposed to the second disc 55, a coil spring 61 that pushes the second pushing member 60 toward the second disc 55, and a second coil 67 that generates an electromagnetic force when energized. Accordingly, the second brake device 59 serves as the claimed “differential action restricting mechanism”, the second pushing member 60 serves as the claimed “pushing member”, and the second coil 67 serves as the claimed “second electromagnetic actuator”.

The second pushing member 60 comprises a cylindrical portion 62 extending around a center axis of the second cover 58, and a flange portion 63 expanding from a base portion of the cylindrical portion 62 along the second disc 55. An outer circumferential edge of the flange portion 63 is splined to an inner circumferential face of the second cover 58 so that the second pushing member 60 is allowed to reciprocate in an axial direction of the second cover 58 but restricted to be rotated. In addition, the flange portion 63 comprises an annular protrusion 64 protruding toward the second disc 55 from an outer circumferential portion thereof to be contacted to the second disc 55, and another annular protrusion 65 protruding toward the second cover 58 from the outer circumferential portion thereof. Specifically, the coil spring 61 is a compressed spring, and wound around the cylindrical portion 62 between the flange portion 63 and the bottom face of the second cover 58.

An annular pedestal 66 is formed on the inner bottom face of the second cover 58. An inner diameter of the pedestal 66 is smaller than that of the annular protrusion 65, and the second coil 67 is wound along an inner circumferential face of the pedestal 66.

Here will be explained an action of the second brake device 59. When the current is not applied to the second coil 67, the second pushing member 60 is pushed by the coil spring 61 toward the second disc 55. Consequently, the second pushing member 60 is brought into frictional contact to the second disc 55. In this situation, since the second pushing member 60 is not allowed to rotate, a rotational speed of the second disc 55 is reduced by the friction acting between the second pushing member 60 and the second disc 55. Consequently, a brake torque is applied to the output shaft 53 of the differential motor 5.

When the current is applied to the second coil 67, the second pushing member 60 is attracted toward the bottom face of the second cover 58 by an electromagnetic force generated by the second coil 67. Specifically, the electromagnetic force of the second coil 67 counteracts to an elastic force of the coil spring 61 to withdraw the second pushing member 60 from the second disc 55, and a contact pressure between the second pushing member 60 and the second disc 55 can be reduced by increasing the electromagnetic force of the second coil 67. Consequently, the friction acting between the second pushing member 60 and the second disc 55 is reduced thereby reducing the brake torque applied to the output shaft 53. Eventually, when the electromagnetic force of the second coil 67 overwhelms the elastic force of the coil spring 61, the second pushing member 60 is isolated away from the second disc 55 so that the output shaft 53 is allowed to rotate.

A unit of the differential motor 5 and the second brake device 59 is attached to the casing 28, and consequently the output gear 54 is held in the casing 28.

In the casing 28, the output gear 54 is meshed with a counter gear 68 fitted onto one end of a countershaft 69 extending parallel to the output shaft 53 of the differential motor 5, and the counter gear 68 is diametrically larger than the output gear 54. A counter drive gear 70 is also fitted onto the countershaft 69 that is diametrically smaller than the counter gear 68 to be connected to the counter gear 68 while being meshed with the external tooth of the first ring gear 34. Thus, torque of the differential motor 5 is applied to the first ring gear 34 while being multiplied. Alternatively, the torque of the differential motor 5 may also be applied to the second ring gear 38.

In the torque vectoring device 1, the drive motor 2 generates drive torque to propel the vehicle. In order to reduce a current value applied to the drive motor 2 during propulsion of the vehicle, the first coil 22 is not energized and the plate member 20 is isolated away from the first pushing member 19.

The output torque of the drive motor 2 is applied to the first sun gear 33 and the second sun gear 37. Consequently, the torque is applied to the first ring gear 34 in the opposite direction to that applied to the first sun gear 33, and the torque is applied to the second ring gear 38 in the opposite direction to that applied to the second sun gear 37. That is, torques are applied to the first ring gear 34 of the first planetary gear unit 31 and the second ring gear 38 of the second planetary gear unit 32 in the same direction. However, since the first ring gear 34 and the second ring gear 38 are connected through the torque reversing mechanism 41, the torques of the first ring gear 34 and the second ring gear 38 counteract to each other. Consequently, the first ring gear 34 serves as the reaction element of the first planetary gear unit 31, and the second ring gear 38 serves as the reaction element of the second planetary gear unit 32.

As described, the first planetary gear unit 31 and the second planetary gear unit 32 are structurally identical to each other. In addition, the first sun gear 33 and the second sun gear 37 are connected to each other through the rotary shaft 30, and the first ring gear 34 and the second ring gear 38 are individually connected to the torque reversing mechanism 41. In the torque vectoring device 1, therefore, rotations of the first ring gear 34 and the second ring gear 38 are stopped when the vehicle travels in a straight line while rotating the right drive wheel 3b and the left drive wheel 3a at the same speed. In this situation, the first planetary gear unit 31 and the second planetary gear unit 32 individually serve as a speed reducer so that the output torque of the drive motor 2 is distributed to the right drive wheel 3b and the left drive wheel 3a while being amplified.

By contrast, during turning of the vehicle, a relative rotation is caused between the first ring gear 34 and the second ring gear 38 and consequently the differential motor 5 is rotated. For example, when the right drive wheel 3b connected to the second carrier 40 is rotated faster than the left drive wheel 3a connected to the first carrier 36, the first sun gear 33 and the second sun gear 37 are still rotated at the same speed and hence it is necessary to absorb a speed difference between the first carrier 36 and the second carrier 40 by absorbing a speed difference between the first ring gear 34 and the second ring gear 38.

In this situation, as a result of rotating the first ring gear 34 and the second ring gear 38 at different speeds, the differential motor 5 is rotated by such speed difference through the second ring gear 38, the counter drive gear 68, the output gear 54, and the output shaft 53. Although the first ring gear 34 and the second ring gear 38 are thus rotated, rotational speeds of the first ring gear 34 and the second ring gear 38 are rather slow. In the torque vectoring device 1, therefore, the first planetary gear unit 31 and the second planetary gear unit 32 are allowed to serve as the speed reducers to amplify the output torque of the drive motor 2 distributed to the right drive wheel 3b and the left drive wheel 3a while amplifying even during turning.

Thus, the differential motor 5 is rotated by the relative rotation between the right drive wheel 3b and the left drive wheel 3a. However, it is preferable to rotate the right drive wheel 3b and the left drive wheel 3a at the same speed if the vehicle travels in a straight line or if a turning radius is large. In addition, it is also preferable to prevent the relative rotation between the right drive wheel 3b and the left drive wheel 3a if a friction coefficient between the right drive wheel 3b and a road surface and a friction coefficient between the left drive wheel 3a and the road surface are different, or if a resistance between one of the drive wheels 3a and 3b and the road surface is differentiated from that between the other wheel and the road surface when one of the drive wheels 3a and 3b drives over a curbstone or the like.

In order to prevent an unintentional relative rotation between the right drive wheel 3b and the left drive wheel 3a when travelling in the straight line, a brake torque of the second brake device 59 is applied to the output shaft 53 of the differential motor 5 in such a manner as to restrict a differential action of the differential unit 4. Specifically, when rotating the right drive wheel 3b and the left drive wheel 3a at the same speed while propelling the vehicle in the straight line, current supply to the second coil 67 is stopped to apply the brake torque to the output shaft 53 of the differential motor 5. Consequently, a running stability of the vehicle travelling in the straight line can be improved. In addition, since the brake torque can be applied to the output shaft 53 of the differential motor 5 without supplying current to the second coil 67, electric consumption can be reduced without requiring a complex control of the differential motor 5.

By contrast, when the differential motor 5 generates a torque, a reaction torque of the first ring gear 34 as the reaction element of the first planetary gear unit 31 is changed thereby changing an output torque of the first carrier 36. For example, when the differential motor 5 generates a torque in such a manner as to increase the reaction torque of the first ring gear 34, the output torque of the first carrier 36 is increased. In this situation, the torque is applied to the second ring gear 38 through the torque reversing mechanism 41 in a direction to reduce the reaction torque thereof, and consequently the output torque of the second carrier 40 is reduced. Thus, the torque split ratio to the right drive wheel 3b and the left drive wheel 3a can be changed by generating torque by the differential motor 5 irrespective of the speed difference between the right drive wheel 3b and the left drive wheel 3a.

In the case of changing the torque split ratio to the right drive wheel 3b and the left drive wheel 3a, a larger output torque is required for the differential motor 5 if the output shaft 53 of the differential motor 5 is subjected to the brake torque. In this case, therefore, the second pushing member 60 is isolated away from the second disc 55 by applying current to the second coil 67. For this reason, turning stability of the vehicle can be improved while reducing electric consumption.

When applying a braking force to the vehicle, the brake torque is generated not only by the drive motor 2 but also by the first brake device 18. That is, the current is supplied to the first brake device 18 depending on the required brake torque. In this case, the brake torque is also applied to the right drive wheel 3b and the left drive wheel 3a while being multiplied. That is, sufficient brake torque can be applied to the right drive wheel 3b and the left drive wheel 3a by the small first brake device 18. According to the preferred embodiment, therefore, the torque vectoring device 1 can be downsized. In addition, the torque split ratio to the right drive wheel 3b and the left drive wheel 3a may also be changed while braking the vehicle by generating torque by the differential motor 5 while applying current to the second coil 67. Further, the relative rotation between the right drive wheel 3b and the left drive wheel 3a may also be prevented during travelling in the straight line by applying the brake torque of the second brake device 18 to the output shaft 53 of the differential motor 5 without applying current to the second coil 67.

When the vehicle is parked, the vehicle is powered off and hence the first coil 22 and the second coil 67 cannot be energized. In order to maintain the braking force applied to the right drive wheel 3b and the left drive wheel 3a when the vehicle is powered off or when a shift lever is shifted to the parking position, the first pushing member 19 is brought into contact to the first disc 13 by activating the parking motor 21, and then the current supply to the parking motor 21 is stopped. On the other hand, in the second brake device 59, the second pushing member 60 is elastically pushed onto the second disc 55 by the coil spring 61 when the current supply to the second coil 67 is stopped so that the brake torque applied to the output shaft 53 of the differential motor 5 can be maintained.

Thus, the vehicle can be stopped during parking by applying the brake torque to the right drive wheel 3b and the left drive wheel 3a. If the friction coefficient between the right drive wheel 3b and the road surface and the friction coefficient between the left drive wheel 3a and the road surface are different during parking, the vehicle may be turned in the yawing direction by a relative rotation between the right drive wheel 3b and the left drive wheel 3a resulting from differential action of the differential unit 4. However, since the brake torque applied to the output shaft 53 of the differential motor 5 can be maintained during parking, such unintentional rotation of the vehicle can be prevented.

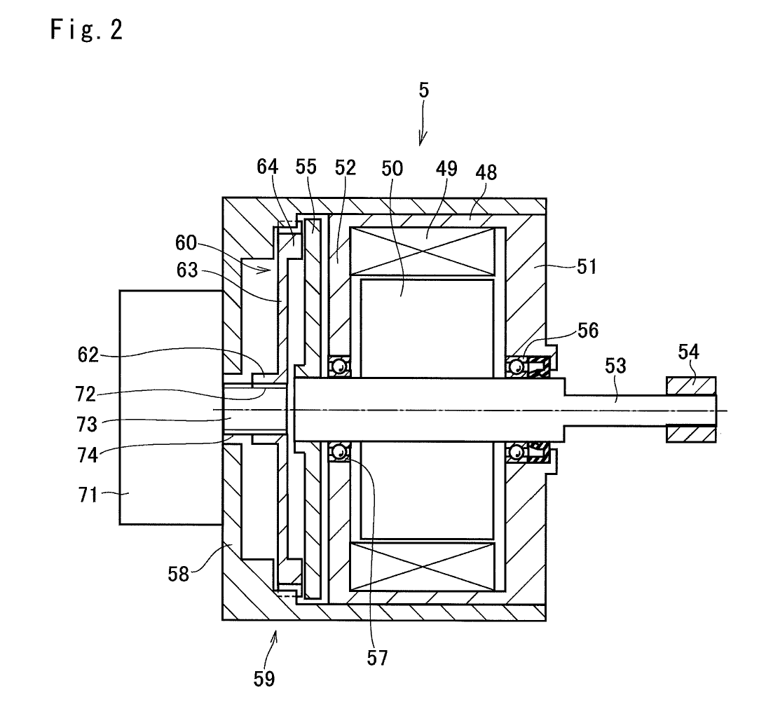

Turning now to FIG. 2, there is shown another example of the second brake device 59. In the following explanation, common reference numerals are allotted to the elements in common with those in the embodiment shown in FIG. 1, and detailed explanation for those common elements will be omitted. According to another example, the second pushing member 60 is brought into contact to the second disc 55 by a feed screw mechanism as the first brake device 18 shown in FIG. 1. According to another example, specifically, the second brake device 59 comprises the second disc 55, the second pushing member 60 and a differential action restricting motor 71. A second female thread 72 is formed on an inner circumferential face of a cylindrical portion 62, and a second male thread 74 is formed on an outer circumferential face of an output shaft 73 of the differential action restricting motor 71 to be mated with the second female thread 72. As described, the outer circumferential edge of the of the flange portion 63 is splined to the inner circumferential face of the second cover 58 so that the second pushing member 60 is allowed to reciprocate in an axial direction of the second cover 58 but restricted to be rotated. That is, the second pushing member 60 is reciprocated toward and away from the second disc 55 by activating the differential action restricting motor 71. Accordingly, the differential action restricting motor 71 serves as the claimed “second electromagnetic actuator”.

According to the second example, the second pushing member 60 is brought into contact to the second disc 55 by the differential action restricting motor 71 when propelling the vehicle in the straight line to restrict a relative rotation between the right drive wheel 3b and the left drive wheel 3a, or during parking the vehicle. By contrast, the second pushing member 60 is isolated away from the second disc 55 by the differential action restricting motor 71 when changing the torque split ratio to the right drive wheel 3b and the left drive wheel 3a, or when allowing the right drive wheel 3b and the left drive wheel 3a to rotate at different speeds. Thus, the above-mentioned advantages of the preferred embodiment may also be achieved.

In addition, in order to control the torque split ratio to the right drive wheel 3b and the left drive wheel 3a, and to allow a relative rotation between the right drive wheel 3b and the left drive wheel 3a, the output shaft 53 of the differential motor 5 may be allowed to rotate by isolating the second pushing member 60 away from the second disc 55 by the differential action restricting motor 71. In this case, current supply to the differential action restricting motor 71 is stopped after isolating the second pushing member 60 away from the second disc 55 and hence electric consumption of the second brake device 59 may also be reduced during propulsion of the vehicle.

Although the above exemplary embodiment of the present application has been described, it will be understood by those skilled in the art that the torque vectoring device according to the present application should not be limited to the described exemplary embodiment, and various changes and modifications can be made within the spirit and scope of the present application.

What is claimed is:

1. A torque vectoring device, comprising:
a drive motor;
a differential unit including
a first planetary gear unit having a first input element to which torque of the drive motor is applied, a first output element connected to one of drive wheels, and a first reaction element which establishes reaction torque to output the torque of first input element from the first output element, and
a second planetary gear unit having a second input element to which torque of the drive motor is applied, a second output element connected to the other drive wheel, and a second reaction element which establishes reaction torque to output the torque of second input element from the second output element;
a differential motor that applies torque to any one of the first reaction element and the second reaction element;
a torque reversing mechanism that transmits the torque of the first reaction element to the second reaction element while reversing a direction;
a rotary shaft connecting the first input element and the second input element;
a first rotary member fitted onto an output shaft of the differential motor; and
a differential action restricting mechanism that brings a pushing member into frictional contact to the first rotary member thereby applying brake torque to the output shaft of the differential motor.

2. The torque vectoring device as claimed in claim 1, further comprising:
a second rotary member fitted onto an output shaft of the drive motor;
another pushing member that is selectively brought into frictional contact to the second rotary member; and
a first electromagnetic actuator that is energized to reciprocate said another pushing member toward and away from second rotary member.

3. The torque vectoring device as claimed in claim 2, wherein:
the first electromagnetic actuator includes a parking motor,
the parking motor comprises a first male thread formed on an outer circumferential face of an output shaft of the parking motor,
the first electromagnetic actuator further includes an annular plate member having a first female thread formed on an inner circumferential face thereof to be mated with the first male thread, and
the plate member pushes said another pushing member toward the second rotary member.

4. The torque vectoring device as claimed in claim 1, wherein the differential action restricting mechanism includes a second electromagnetic actuator that reduces a frictional force applied to the first rotary member when energized.

5. The torque vectoring device as claimed in claim 4, wherein:
the second electromagnetic actuator includes a differential action restricting motor, and
the second electromagnetic actuator comprises a second male thread formed on an outer circumferential face of an output shaft of the differential action restricting motor, and a second female thread is formed on an inner circumferential face of the pushing member to be mated with the second male thread.

6. The torque vectoring device as claimed in claim 1, wherein
the first planetary gear unit serves as a speed reducer when the first reaction element is rotated slower than the first input element, and
the second planetary gear unit serves as a speed reducer when the second reaction element is rotated slower than the second input element.
